(19) United States
(12) Patent Application Publication
(10) Pub. No.: US 2025/0065557 A1
(43) Pub. Date: Feb. 27, 2025

(54) RELEASE PROTECTION FILM AND METHOD FOR MANUFACTURING THE SAME

(71) Applicant: NAN YA PLASTICS CORPORATION, TAIPEI (TW)

(72) Inventors: TE-CHAO LIAO, TAIPEI (TW); CHING-YAO YUAN, TAIPEI (TW); Chih-Feng Wang, TAIPEI (TW); TENG-KO MA, TAIPEI (TW)

(21) Appl. No.: 18/496,905

(22) Filed: Oct. 29, 2023

(30) Foreign Application Priority Data
Aug. 24, 2023 (TW) 112131824

(51) Int. Cl. B29C 59/04; B29C 48/00; B29C 48/08

(52) U.S. Cl. CPC B29C 59/04; B29C 48/0018; B29C 48/002; B29C 48/08; B29K 2023/083; B29K 2023/10; B29L 2007/008

(57) ABSTRACT

A release protection film and a method for manufacturing the same are provided. The method includes: preparing a resin material; subjecting the resin material to an extrusion process and a stretching process, so as to form a resin membrane; and forming an embossed pattern having a depth of from 1 μm to 5 μm onto the resin membrane by an embossing roller, so as to form the release protection film. The resin material includes a polyolefin material and a petroleum resin. Based on a total weight of the polyolefin material being 100 phr, an amount of the petroleum resin ranges from 5 phr to 20 phr.

### CROSS-REFERENCE TO RELATED PATENT APPLICATION

This application claims the benefit of priority to Taiwan Patent Application No. 112131824, filed on Aug. 24, 2023. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a release protection film and a method for manufacturing the same, and more particularly to a release protection film and a method for manufacturing the same that can be applied to a large-sized display or a panel.

### BACKGROUND OF THE DISCLOSURE

Generally, a protection film needs to have a sufficient structural strength to achieve a protection effect. The protection film currently available on the market can be a cast polypropylene (CPP) film manufactured by an extrusion process or a blown film process.

However, as the CPP film manufactured by the extrusion process or the blown film process has a smooth surface, a peeling force of the CPP film is high. When the CPP film is attached onto a display or a panel to serve as a protection film, the CPP film cannot be easily separated from the display or the panel, and is inconvenient for use.

Hence, in the conventional technology, a release layer is disposed on the CPP film by a coating process, so that a roughness of a surface of the protection film can be increased, and a peeling force of the protection film relative to the display or the panel can be decreased. After use, the protection film can be easily separated from the display or the panel. However, in terms of an overall manufacturing process, the coating process increases the complexity of the overall manufacturing process, and use of solvents is environmentally unfriendly.

Moreover, the size of the display and the panel increases with the advancement of technology. For a large-sized (40 inches to 100 inches) display or panel, the protection film is required to have a good adhesion for being attached onto the display or panel, but is also required to have a low peeling force for separation therefrom.

Therefore, how to enable the protection film to have both a sufficient adhesive force and a low peeling force through improvements in material design and a manufacturing method, so as to meet use requirements of the large-sized display or panel currently available on the market, has become one of the important issues to be solved in this industry.

### SUMMARY OF THE DISCLOSURE

In response to the above-referenced technical inadequacies, the present disclosure provides a release protection film and a method for manufacturing the same.

In order to solve the above-mentioned problems, one of the technical aspects adopted by the present disclosure is to provide a method for manufacturing a release protection film. The method includes: preparing a resin material; subjecting the resin material to an extrusion process and a stretching process, so as to form a resin membrane; and forming an embossed pattern having a depth of from 1 μm to 5 μm onto the resin membrane by an embossing roller, so as to form the release protection film. The resin material includes a polyolefin material and a petroleum resin. Based on a total weight of the polyolefin material being 100 phr, an amount of the petroleum resin ranges from 5 phr to 20 phr.

In one of the possible or preferred embodiments, the release protection film is manufactured in a continuous process, and the release protection film is integrally formed.

In one of the possible or preferred embodiments, the petroleum resin is a hydrogenated petroleum resin.

In one of the possible or preferred embodiments, the petroleum resin is a hydrogenated petroleum resin polymerized from a monomer having a carbon number of 5 or a hydrogenated petroleum resin polymerized from a monomer having a carbon number of 9.

In one of the possible or preferred embodiments, based on a total weight of the polyolefin material being 100 wt %, the polyolefin material includes 15 wt % to 65 wt % of a propylene polymer and 35 wt % to 85 wt % of an ethylene polymer.

In one of the possible or preferred embodiments, based on a total weight of the polyolefin material being 100 wt %, the polyolefin material includes 50 wt % to 70 wt % of a propylene polymer, 10 wt % to 30 wt % of an ethylene polymer, and 10 wt % to 25 wt % of an ethylene vinyl acetate copolymer.

In one of the possible or preferred embodiments, a stretch ratio of the resin material in the stretching process ranges from 3.5 to 4.5.

In one of the possible or preferred embodiments, the depth of the embossed pattern formed on the resin membrane ranges from 1 μm to 3 μm.

In order to solve the above-mentioned problems, another one of the technical aspects adopted by the present disclosure is to provide a release protection film that is manufactured by the method mentioned above. A peeling force of the release protection film attached on a glass surface ranges from 130 g/25 mm to 200 g/25 mm.

In one of the possible or preferred embodiments, a haze of the release protection film is lower than 5.2%.

Therefore, in the release protection film and the method for manufacturing the same provided by the present disclosure, by virtue of “an amount of the petroleum resin ranging from 5 phr to 20 phr,” and “forming an embossed pattern having a depth of from 1 μm to 5 μm onto the resin membrane by an embossing roller,” the release protection film can be easily attached onto a glass surface and have an appropriate peeling force relative to the glass surface. In this way, the process of manufacturing a release protection film having a high structural strength and a low peeling force can be simplified.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a flowchart of a method for manufacturing a release protection film according to the present disclosure; and

FIG. 2 is a schematic view of the release protection film according to the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

In order to overcome problems such as a complicated process for manufacturing a protection film and the difficulty of enabling the protection film to have both a high structural strength and a low peeling force, improvements are made to the material of the protection film and the process of manufacturing the protection film in the present disclosure. Accordingly, the improved protection film can be applied to a large-sized display or panel in the optoelectronic industry.

An embossed pattern is formed on a surface of a release protection film of the present disclosure by an embossing roller. The embossed pattern can decrease a peeling force of the release protection film attached on a glass surface. In addition, the release protection film of the present disclosure is integrally formed, and can be easily peeled off without needing to dispose a release layer by a coating process or a lamination process. Moreover, the release protection film of the present disclosure can be manufactured in a continuous process, thereby having the advantage of simplified production.

A specific material is chosen to manufacture the release protection film of the present disclosure, such that the release protection film can have both a high structural strength and a low haze.

Through selection of the specific material, an adhesive force between the release protection film and the glass surface can be slightly increased in the present disclosure. Under the condition that the release protection film can still be conveniently peeled off, the release protection film can be attached onto a display or a panel with an improved adhesive force. In other words, the release protection film of the present disclosure has a good adhesion with a glass substrate having a large area, and is thus applicable to the large-sized (40 inches to 100 inches) display or panel.

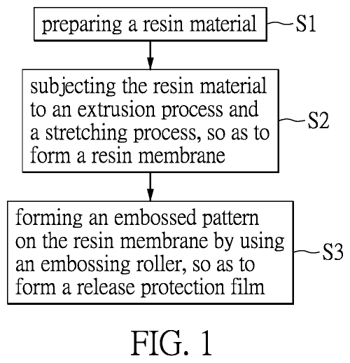

Referring to FIG. 1, a method for manufacturing a release protection film includes the following steps: preparing a resin material (step S1); subjecting the resin material to an extrusion process and a stretching process, so as to form a resin membrane (step S2); and forming the release protection film by using an embossing roller (step S3).

In step S1, the resin material includes a polyolefin material and a petroleum resin. The polyolefin material is a main component of the release protection film. For example, an amount of the polyolefin material in the release protection film is higher than 70 wt %.

In an exemplary embodiment, the polyolefin material at least includes a propylene polymer and an ethylene polymer. An addition of the petroleum resin can increase a peeling force of the release protection film attached onto a glass surface. Furthermore, the addition of the petroleum resin can decrease a haze of the resin material. For an actual product, a haze of the release protection film is preferably lower than 5.2%.

According to experiments, when the petroleum resin is added in an excessive amount, a viscosity of the resin material can be too high (which is not beneficial for production). However, without a sufficient amount of the petroleum resin, the peeling force of the release protection film attached onto the glass surface will be decreased.

Specifically, based on a total weight of the polyolefin material being 100 phr, an amount of the petroleum resin ranges from 5 phr to 20 phr. For example, the amount of the petroleum resin can be 6 phr, 8 phr, 10 phr, 12 phr, 14 phr, 16 phr, or 18 phr.

In an exemplary embodiment, the petroleum resin can be a hydrogenated petroleum resin. Specifically, the petroleum resin is a hydrogenated petroleum resin polymerized from a monomer having a carbon number of 5 or a hydrogenated petroleum resin polymerized from a monomer having a carbon number of 9.

For example, the petroleum resin can be a piperylene hydrogenated resin or a dicyclopentadiene (DCPD) hydrogenated resin. The petroleum resin can also be a water-based white thermoplastic resin obtained by polymerization and hydrogenation of a C9 fraction (a byproduct from ethylene cracking). However, the present disclosure is not limited thereto.

The material of the polyolefin material can also influence the peeling force of the release protection film attached onto the glass surface. In an exemplary embodiment, the polyolefin material includes a propylene polymer and an ethylene polymer.

The propylene polymer can be a random propylene polymer, a propylene copolymer (polymerized from a propylene monomer and an ethylene monomer), a propylene terpolymer (polymerized from a propylene monomer, an ethylene monomer, and a butylene monomer), or a block propylene polymer.

In an exemplary embodiment, the propylene polymer is the block propylene polymer. The block propylene polymer has a low crystallinity, such that an embossed pattern can be well formed on the release protection film, and air bubbles can be prevented from forming between the release protection film and the glass surface.

Specifically, a melting point of the random propylene polymer ranges from 140° C. to 150° C., and preferably from 142° C. to 146° C. A melt flow index of the random propylene polymer ranges from 2 to 5, and preferably from 2 to 4.

In an exemplary embodiment, the ethylene polymer can be a linear low density ethylene polymer. Specifically, a melt flow index of the linear low density ethylene polymer ranges from 2 to 5, and preferably from 2 to 4.

A weight ratio of the propylene polymer to the ethylene polymer is also controlled in the present disclosure, so as to adjust a texture of the polyolefin material. Based on a total weight of the polyolefin material being 100 wt %, the polyolefin material includes 15 wt % to 65 wt % of the propylene polymer and 35 wt % to 85 wt % of the ethylene polymer.

For example, an amount of the propylene polymer can be 20 wt %, 30 wt %, 40 wt %, 50 wt %, or 60 wt %. An amount of the ethylene polymer can be 40 wt %, 50 wt %, 60 wt %, 70 wt %, or 80 wt %.

In addition to the propylene polymer and the ethylene polymer, the polyolefin material can further include ethylene vinyl acetate copolymer.

Under the condition that the release protection film can still be easily peeled off, an addition of the ethylene vinyl acetate copolymer can enhance an adhesive force between the release protection film and the glass surface. Accordingly, the release protection film can be applied to a large-sized display or panel.

However, an amount of the ethylene vinyl acetate copolymer needs to be controlled within a specific range. When the amount of the ethylene vinyl acetate copolymer is too high, the viscosity of the resin material will increase and cannot be easily processed. When the amount of the ethylene vinyl acetate copolymer is too low, the adhesive force between the release protection film and the glass surface will decrease, and the release protection film cannot be well attached onto the glass surface.

Therefore, contents and portions of the propylene polymer, the ethylene polymer, and the ethylene vinyl acetate polymer are further controlled in the present disclosure, so as to adjust properties of the polyolefin material. Based on the total weight of the polyolefin material being 100 wt %, the polyolefin material includes 50 wt % to 70 wt % of the propylene polymer, 10 wt % to 30 wt % of the ethylene polymer, and 10 wt % to 25 wt % of the ethylene vinyl acetate polymer. Preferably, based on the total weight of the polyolefin material being 100 wt %, the amount of the ethylene vinyl acetate polymer ranges from 15 wt % to 25 wt %.

By controlling the contents of the materials above, the release protection film of the present disclosure can have both a good adhesion and an appropriate peeling force. Hence, the release protection film can be applied to a large-sized display or panel in the optoelectronic industry.

In the extrusion process of step S2, a temperature of an extruder is controlled to range from 170° C. to 240° C., so as to extrude the resin material.

In the stretching process of step S2, the resin material is subsequently stretched at a temperature ranging from 100° C. to 160° C. by a stretch ratio of from 3 times to 5 times, so as to form the resin membrane. Preferably, the resin material is stretched by a stretch ratio of from 3.5 times to 4.5 times. More preferably, the resin material is stretched by a stretch ratio of 4 times. For example, when the resin material is stretched by a stretch ratio of 5 times, a rigidity of the resin membrane increases, but the adhesive force between the release protection film and the glass surface decreases.

In step S3, an embossed pattern having a depth ranging from 1 μm to 5 μm is formed onto the resin membrane by the embossing roller, so as to form the release protection film. Preferably, the depth of the embossed pattern formed onto the resin membrane ranges from 1 μm to 3 μm.

In an exemplary embodiment, a pattern on the embossing roller is diamond-shaped. The depth of the diamond-shaped pattern ranges from 0.5 mm to 1.5 mm, and preferably from 0.75 mm to 1.25 mm.

Specifically, steps S1 to S3 are performed in a continuous process. As such, the method of the present disclosure has the advantage of being simple to implement. Furthermore, the manufactured release protection film is integrally formed.

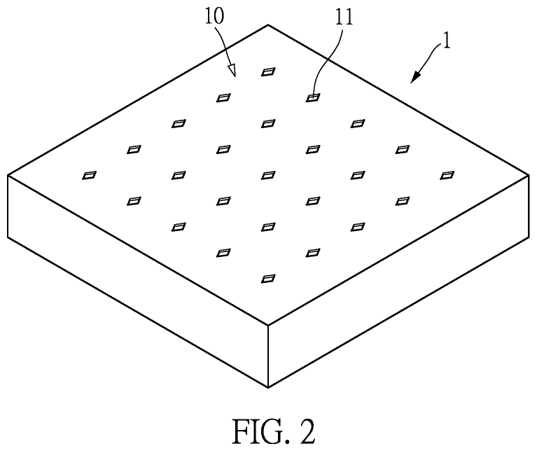

Referring to FIG. 2, an embossed pattern 11 is formed on an attachment surface 10 of a release protection film 1. A concave pattern of the embossed pattern 11 corresponds to a convex pattern of the embossing roller. Due to the embossed pattern 11 of the release protection film 1, a surface area of the release protection film 1 that is in contact with a glass substrate is reduced. In this way, a peeling force of the release protection film attached onto the glass substrate can be decreased.

In addition, by adjusting the depth of the embossed pattern on the resin membrane, the peeling force of the release protection film attached onto the glass substrate can be controlled. The embossed pattern is preferably diamond-shaped, but the present disclosure is not limited thereto. The embossed pattern can have other quadrilateral shapes.

### Examples 1 to 4

In order to prove that the release protection film of the present disclosure can be attached onto the glass substrate and have an appropriate peeling force, release protection films of Examples 1 to 4 are manufactured according to steps S1 to S3 mentioned above. In Examples 1 to 4, the random propylene polymer and the low density ethylene polymer are mixed to form the polyolefin material. The hydrogenated petroleum resin and the polyolefin material are further mixed to form the resin material.

After being subjected to the extrusion step and the stretching step, the resin material is formed into the resin membrane. The embossed pattern is formed onto a surface of the resin membrane by the embossing roller, and then the release protection films in Examples 1 to 4 are obtained. Thicknesses of the release protection films in Examples 1 to 4 range from 100 μm to 150 μm. However, the thickness of the release protection film is not limited thereto. The thickness of the release protection film can be adjusted according to the size of a display or a panel.

A haze and a peeling force of the release protection film are measured, and an adhesion of the release protection film to the glass substrate is evaluated. The specific contents of components in the resin material, a stretch ratio in the stretching step, a depth of the embossed pattern, and properties of the release protection film are listed in Table 1.

The haze of the release protection film is measured according to the ASTM D1003 (CIE C) standard set by American Society for Testing and Materials (ASTM).

In a measurement of the peeling force, the release protection film is rolled by a roller having a weight of 4.5 pounds, so as to be attached onto the glass substrate. Subsequently, the glass substrate is fixed on a lower clamp, and the release protection film is folded by 180° and fixed on an upper clamp. When the release protection film is peeled from the glass substrate by a speed of 30 mm/min at an angle of 180°, the peeling force occurring during the peeling process is measured. An average of the peeling force occurring during the peeling process is shown in Table 1.

In an adhesion test, the adhesion of the release protection film to the glass substrate is categorized into three levels. In Table 1, the symbol “o” indicates that the release protection film can be easily attached onto the glass substrate. The symbol “A” indicates that the release protection film can be easily attached onto the glass substrate, but can also easily wrinkle or become uneven. The symbol “x” indicates that the release protection film cannot be easily attached onto the glass substrate.

### Examples 5 and 6

Release protection films in Examples 5 and 6 are similar to the release protection films in Examples 1 to 4, the difference therebetween being that, in addition to the random propylene polymer and the low density ethylene polymer, the polyolefin material of the release protection films in Examples 5 and 6 further includes the ethylene vinyl acetate copolymer (EVA).

After preparing the resin material shown in Table 1, the resin material is subjected to the extrusion step and the stretching step for formation of the resin membrane. Then, the embossed pattern is formed onto the surface of the resin membrane by the embossing roller, so as to obtain the release protection film. In the manner mentioned above, a haze and a peeling force of the release protection film are measured, and an adhesion of the release protection film to the glass substrate is evaluated. The specific contents of components in the resin material, a stretch ratio in the stretching step, a depth of the embossed pattern, and properties of the release protection film are listed in Table 1.

### Comparative Example 1

The release protection film in Comparative Example 1 is similar to the release protection film in Example 1. However, for the release protection film in Comparative Example 1, the hydrogenated petroleum resin is absent from the resin material, and the release protection film does not have the embossed pattern.

After preparing the resin material shown in Table 1, the resin material is subjected to the extrusion step and the stretching step for formation of the resin membrane. Then, without being treated by the embossing roller, the resin membrane is used to manufacture the release protection film. A haze and a peeling force of the release protection film are measured, and an adhesion of the release protection film to the glass substrate of the release protection film is evaluated. The specific contents of components in the resin material, a stretch ratio in the stretching step, a depth of the embossed pattern, and properties of the release protection film are listed in Table 1.

### Comparative Example 2

The release protection film in Comparative Example 2 is similar to the release protection film in Example 1. However, for the release protection film in Comparative Example 2, the hydrogenated petroleum resin is absent from the resin material.

After preparing the resin material shown in Table 1, the resin material is subjected to the extrusion step and the stretching step for formation of the resin membrane. Then, the embossed pattern is formed onto the surface of the resin membrane by the embossing roller, so as to obtain the release protection film. In the manner mentioned above, a haze and a peeling force of the release protection film are measured, and an adhesion of the release protection film to the glass substrate is evaluated. The specific contents of components in the resin material, a stretch ratio in the stretching step, a depth of the embossed pattern, and properties of the release protection film are listed in Table 1.

TABLE 1

| Resin | | | | | | | Comparative | |
|---|---|---|---|---|---|---|---|---|
| material | Example | | | | | | Example | |
| (phr) | 1 | 2 | 3 | 4 | 5 | 6 | 1 | 2 |
| Propylene | 60 | 60 | 40 | 20 | 60 | 60 | 60 | 60 |
| polymer | | | | | | | | |
| Ethylene | 40 | 40 | 60 | 80 | 20 | 20 | 40 | 40 |
| polymer | | | | | | | | |
| EVA | 0 | 0 | 0 | 0 | 20 | 20 | 0 | 0 |
| copolymer | | | | | | | | |
| Petroleum | 10 | 10 | 10 | 10 | 10 | 10 | 0 | 0 |
| resin | | | | | | | | |

Parameter

| | | | | | | | | |
|---|---|---|---|---|---|---|---|---|
| Stretch ratio | 4 | 5 | 4 | 4 | 4 | 4 | 4 | 4 |
| Depth of | 1 | 1 | 1 | 1 | 1 | 2 | — | 1 |
| embossing | | | | | | | | |
| pattern (μm) | | | | | | | | |

Property of release protection film

| | | | | | | | | |
|---|---|---|---|---|---|---|---|---|
| Haze (%) | 5 | 4.8 | 5.1 | 4.5 | 4.8 | 4 | 7.5 | 7 |
| Peeling | 152 | 137 | 157 | 147 | 170 | 185 | 25 | 40 |
| force | | | | | | | | |
| (g/25 mm) | | | | | | | | |
| Adhesion | ◯ | Δ | ◯ | ◯ | ◯ | ◯ | X | X |

According to the results in Table 1, the release protection film of the present disclosure has an appropriate peeling force (i.e., 120 g/25 mm to 200 g/25 mm), and can be evenly attached onto the glass substrate and be easily peeled off. Specifically, the peeling force of the release protection film is higher than 120 g/25 mm. In order to be easily peeled off, the peeling force of the release protection film is required to be lower than 200 g/25 mm.

According to the results in Examples 5 and 6, when the polyolefin material simultaneously includes the propylene polymer, the ethylene polymer, and the ethylene vinyl acetate copolymer, the peeling force of the release protection film can range from 150 g/25 mm to 200 g/25 mm. Accordingly, the release protection film of the present disclosure can be applied to a large-sized display or panel.

According to the results in Table 1, the addition of the petroleum resin can increase the peeling force to be higher than 120 g/25 mm, and even higher than 145 g/25 mm. Moreover, the addition of the petroleum resin can decrease the haze of the resin material to be lower than 5.2%.

According to the results in Examples 1 and 2, when the stretch ratio in the stretching step is too high, the peeling force of the release protection film will be decreased. Based on experimental results, the preferred stretch ratio ranges from 3 times to 4 times, such that the peeling force of the release protection film can be higher than 145 g/25 mm.

According to the results in Examples 1, 3, and 4, the haze and the peeling force of the release protection film are influenced by the contents of components in the polyolefin material. Within the content range mentioned above, the contents of components in the polyolefin material can be adjusted according to practical requirements.

According to the results in Examples 5 and 6, the peeling force of the release protection film is also influenced by the depth of the embossed pattern. Based on experimental results, the preferred depth of the embossed pattern ranges from 1 μm to 3 μm.

It should be noted that the release protection film of the present disclosure is integrally formed in a continuous process. There is no need to dispose a release layer onto a surface of the release protection film by a coating process or a laminating process. Therefore, the method for manufacturing the release protection film of the present disclosure is simple and environmentally friendly.

### Beneficial Effects of the Embodiments

In conclusion, in the release protection film and the method for manufacturing the same provided by the present disclosure, by virtue of “an amount of the petroleum resin ranging from 5 phr to 20 phr,” and “forming an embossed pattern having a depth ranging from 1 μm to 5 μm onto the resin membrane by an embossing roller,” the release protection film can be easily attached onto a glass surface and have an appropriate peeling force relative to the glass surface. In this way, the process of manufacturing a release protection film having a high structural strength and a low peeling force can be simplified.

Furthermore, the peeling force of the release protection film is influenced by the components in the polyolefin material. When the polyolefin material simultaneously contains the propylene polymer, the ethylene polymer, and the ethylene vinyl acetate copolymer, the peeling force of the release protection film can be enhanced under the condition that the release protection film can still be easily peeled off. Accordingly, the release protection film can be applied to a large-sized display or panel.

In addition, the peeling force of the release protection film is also influenced by the contents of the components in the polyolefin material. When the amount of the ethylene vinyl acetate copolymer is high, the viscosity of the resin material is too high for processing. When the amount of the ethylene vinyl acetate copolymer is low, the peeling force of the release protection film is too low to be well attached onto the glass surface.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A method for manufacturing a release protection film, comprising:
preparing a resin material, wherein the resin material includes a polyolefin material and a petroleum resin; wherein, based on a total weight of the polyolefin material being 100 phr, an amount of the petroleum resin ranges from 5 phr to 20 phr;
subjecting the resin material to an extrusion process and a stretching process, so as to form a resin membrane; and
forming an embossed pattern having a depth of from 1 μm to 5 μm onto the resin membrane by an embossing roller, so as to form the release protection film.

2. The method according to claim 1, wherein the release protection film is manufactured in a continuous process, and the release protection film is integrally formed.

3. The method according to claim 1, wherein the petroleum resin is a hydrogenated petroleum resin.

4. The method according to claim 3, wherein the petroleum resin is a hydrogenated petroleum resin polymerized from a monomer having a carbon number of 5 or a hydrogenated petroleum resin polymerized from a monomer having a carbon number of 9.

5. The method according to claim 1, wherein, based on a total weight of the polyolefin material being 100 wt %, the polyolefin material includes 15 wt % to 65 wt % of a propylene polymer and 35 wt % to 85 wt % of an ethylene polymer.

6. The method according to claim 1, wherein, based on a total weight of the polyolefin material being 100 wt %, the polyolefin material includes 50 wt % to 70 wt % of a propylene polymer, 10 wt % to 30 wt % of an ethylene polymer, and 10 wt % to 25 wt % of an ethylene vinyl acetate copolymer.

7. The method according to claim 1, wherein a stretch ratio of the resin material in the stretching process ranges from 3.5 to 4.5.

8. The method according to claim 1, wherein the depth of the embossed pattern formed on the resin membrane ranges from 1 μm to 3 μm.

9. A release protection film, characterized in that the release protection film is manufactured by the method as claimed in claim 1, and a peeling force of the release protection film attached on a glass surface ranges from 130 g/25 mm to 200 g/25 mm.

10. The release protection film according to claim 9, wherein a haze of the release protection film is lower than 5.2%.
